(19) United States
(12) Patent Application Publication
(10) Pub. No.: US 2006/0133725 A1
(43) Pub. Date: Jun. 22, 2006

(54) Compact and high performance opto-mechanical switch

(76) Inventors: Yong Jian Wang, Saratoga, CA (US); Feng Ye, Alameda, CA (US)

Correspondence Address: SAWYER LAW GROUP LLP, P O BOX 51418, PALO ALTO, CA, 94303, US

(21) Appl. No.: 11/249,886

(22) Filed: Oct. 12, 2005

Related U.S. Application Data
(60) Provisional application No. 60/620,986, filed on Oct. 22, 2004.
(60) Provisional application No. 60/623,131, filed on Oct. 29, 2004.

(51) Int. Cl. G02B 6/26; G02B 6/34; G02B 6/32; G02B 6/42

(52) U.S. Cl. 385/22; 385/16; 385/18; 385/31; 385/33; 385/36

(57) ABSTRACT

A system and method for a 1xN fiber optical switch is disclosed. The switch comprises (1) a pair of vertically oriented wedge prisms and (2) a collimator. The collimator comprises a four fiber ferrule and a lens. When no wedge prisms are inserted into the optical path, the signal is switched to port 1. When the first prism is inserted, the signal is switched to port 2. When the second prism is inserted (first prism not in), the signal is switched to port 3 which is in a vertical line. While both prisms are inserted into the optical path, the signal is switched to the diagonal port 4. Accordingly, a 1xN switch is provided that is more compact than a conventional 1xN switch. The 1xN fiber optical switch in accordance with the present invention have advantages over conventional opto-mechanical switches. The inventive 1xN switch is much smaller in size because all ports are held in one ferrule and only one lens is utilized.

### FIELD OF THE INVENTION

The present invention relates generally to opto-mechanical switches and more specifically to compact and high performance switches.

### BACKGROUND OF THE INVENTION

Opto-mechanical switches are used in routing signals from one port to another port. Opto-mechanical switches are the critical building element in fiber optical communication networks and in other fields such as test and measurement.

Compact 1xN opto-mechanical switches are desirable as technology shrinks in size and increases in bandwidth. A first embodiment of a conventional opto-mechanical switche utilizes a classical design which has 4 separate ports. Four lenses are used which makes the switch costly and bulky. A second embodiment of a conventional opto-mechanical switche utilizes a more compact and hybrid design in which the input signal is divided into two by a pair of 45 degree prisms. Each signal is further divided into two ports through a wedge prism. In this embodiment two lenses are used. Two fibers are held in one ferrule. However, both of its conventional embodiments described above are relatively costly and bulky. Accordingly, what is needed is a system and method for overcoming the above-identified issues. The present invention addresses such a need.

### SUMMARY OF THE INVENTION

A system and method for a 1xN fiber optical switch is disclosed. The switch comprises (1) a pair of vertically oriented wedge prisms and (2) a collimator. The collimator comprises a four fiber ferrule and a lens. When no wedge prisms are inserted into the optical path, the signal is switched to port 1. When the first prism is inserted, the signal is switched to port 2. When the second prism is inserted (first prism not in), the signal is switched to port 3 which is in a vertical line. While both prisms are inserted into the optical path, the signal is switched to the diagonal port 4. Accordingly, a 1xN switch is provided that is more compact than a conventional 1xN switch.

The 1xN fiber optical switch in accordance with the present invention have advantages over conventional opto-mechanical switches. The inventive 1xN switch is much smaller in size because all ports are held in one ferrule and only one lens is utilized.

### BRIEF DESCRIPTION OF THE DRAWINGS

FIG. 1 is a diagram of a first embodiment of a conventional 1x4 or 1xN switch.

FIG. 2 is a diagram of a second embodiment of a conventional 1x4 or 1xN switch.

FIG. 3 is a diagram of a refractive prism.

FIG. 4 illustrates a four fiber ferrule, showing the fiber arrangement.

FIGS. 5A, 5B and 5C is a diagram showing how switching is achieved from three different views.

FIG. 6 is a diagram of a nine fiber ferrule which shows the fiber arrangement.

### DETAILED DESCRIPTION

The present invention relates generally to opto-mechanical switches and more specifically to compact and high performance switches. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

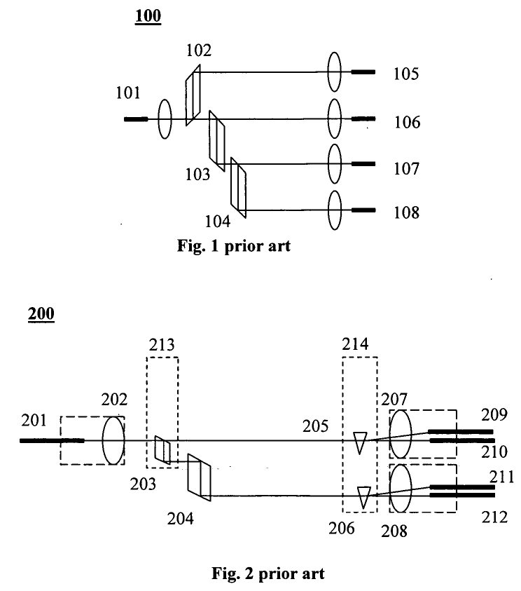

FIG. 1 shows a first embodiment of a conventional 1x4 or 1xN switch 100. The switch 100 comprises single fiber collimators 105, 106, 107, 108 and 101, and 45-degree angle prisms 102, 103 and 104. The light beam from collimator 101 can be shifted into collimators 105, 106, 107 and 108 when the prism(s) 102, 103 and 104 is (are) in or out of the optical path.

FIG. 2 shows a second embodiment of a conventional 1xN switch 200. The switch 200 comprises a single fiber collimator 202 with a fiber 201, two dual fiber collimators 207, 208 with fibers 209, 210, 211, 212, two small angle prisms 205 and 206, one moving 45° prism 203 and one fixed 45° prism 204 comes from collimator 202 and goes into collimator fibers 209 and 210 of the collimator 207 when the prism 203 is out of the optical path. Likewise, the light goes into collimator fibers 211, 212 of the collimator 208 when the prism 203 is in the optical path.

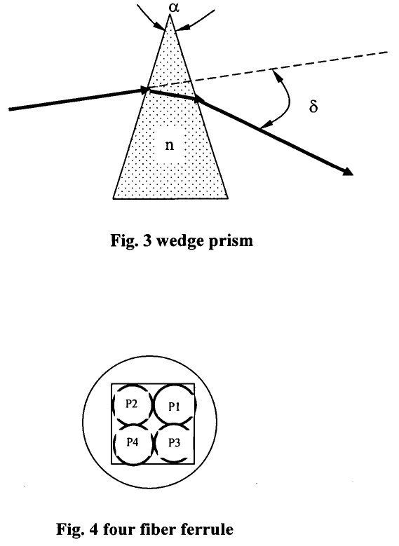

FIG. 3 is a sketch of a refractive prism. If the beam angles are less than 5°, the refractive angle is approximately δ=(n−1)α. In this figure, δ is the refractive angle, n is the refractive index of the prism material and α is the angle of the prism.

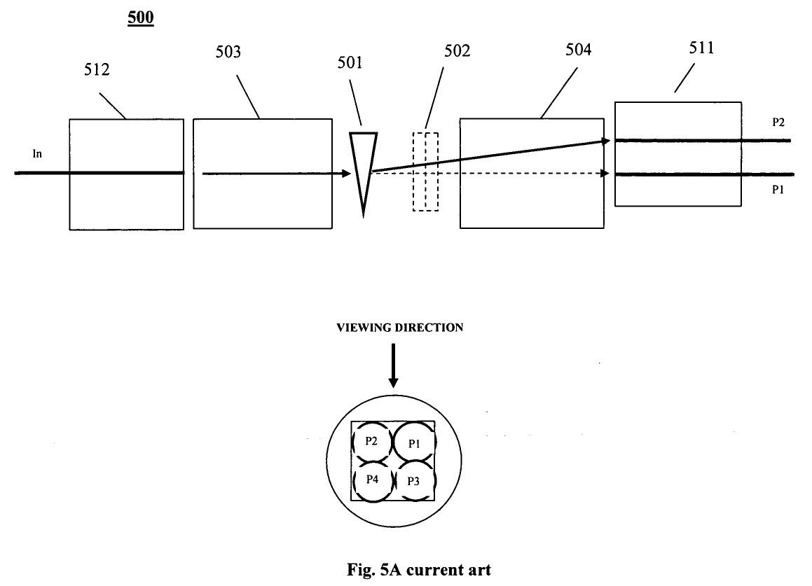

FIG. 4 shows a four fiber ferrule 511. Four fibers P1, P2, P3 and P4 are arranged to form a rectangular shape with sides touching each other.

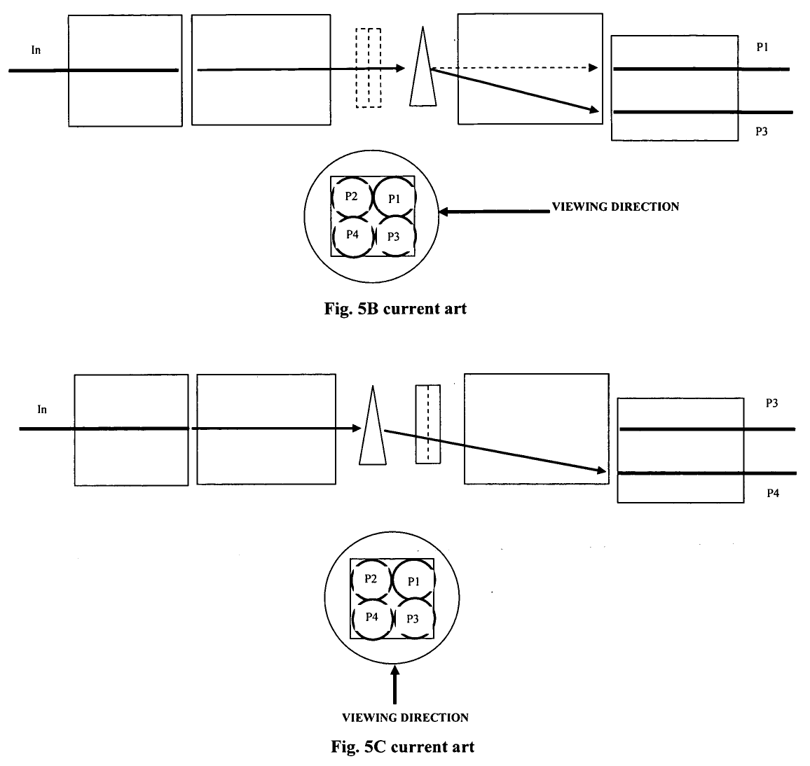

FIGS. 5A, 5B and 5C show how switching is achieved utilizing the four fiber ferrule 400 of FIG. 4 from three different views. The opto-mechanical switch comprises a single fiber ferrule 512, quarter pitch GRIN lens or C lenses 503 and 504, a four fiber ferrule 511 as shown in FIG. 4, and a pair of wedge prisms 501 and 502 as shown in FIG. 3. The single fiber ferrule 512 holds “in” fiber port. The two wedge prisms 501 and 502 are oriented to each other by 90 degrees. The top angle α is designed such that δ angle is shifted when light passes through the prism and enter the adjacent fiber core. Each of the prisms 501 and 502 is attached to a relay (not shown) through a metal arm (not shown). With the voltage control, the wedge prisms 501 and 502 can be either in or out of the optical path and thus switch signals to different ports with different prism combinations.

In FIG. 5A, when viewed from the top, if both prisms 501 and 502 are not in the optical path, the light signal goes from “in” to fiber/port P1. If prism 501 is in and prism 502 is out, the light signal goes from “in” to fiber/port P2.

In FIG. 5B, when viewed from the side, if prism 501 is out and prism 502 is in, the light signal goes to fiber/port P3.

In FIG. 5C, if both prisms 501 and 502 are in, the light signal goes to the diagonal port P4 due to vector combination effect.

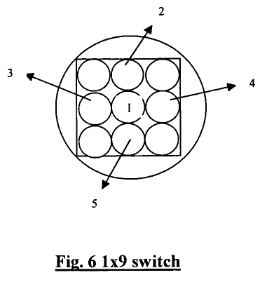

FIG. 6 shows a ferrule with 9 fibers. With the same principle, a 1x9 switch can be created.

A system and method for a 1xN fiber optical switch is disclosed. The switch comprises (1) a pair of vertically oriented wedge prisms and (2) a collimator. The collimator comprises a four fiber ferrule and a lens. When no wedge prisms are inserted into the optical path, the signal is switched to port 1. When the first prism is inserted, the signal is switched to port 2. When the second prism is inserted (first prism not in), the signal is switched to port 3 which is in a vertical line. While both prisms are inserted into the optical path, the signal is switched to the diagonal port 4. Accordingly, a 1xN switch is provided that is more compact than a conventional 1xN switch.

The 1xN fiber optical switch in accordance with the present invention have advantages over conventional opto-mechanical switches. The inventive 1xN switch is much smaller in size because all ports are held in one ferrule and only one lens is utilized.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. 1x4 or 1xN switch design:
An 1xN opto-mechanical switch comprising:
a single fiber ferrule;
a first lens for receiving a beam from the single fiber ferrule;
a wedge prism system for directing the beam from the single fiber ferrule;
a second lens for receiving the directed beam from the wedge prism system; and
a substantially square fiber ferrule, the substantially square fiber ferrule containing a plurality of fibers for receiving the beam from the second lens.

2. The 1xN opto-mechanical switch of claim 1 wherein the wedge prism system comprises two wedge prisms with a substantially 90 degree orientation to each other.

3. The 1xN opto-mechanical switch of claim 1 wherein the 1xN switch can be any of a 1x4, 1x9, 1x16 switch.

4. A 1x4 opto-mechanical switch comprising:
a single fiber ferrule;
a first lens for receiving a beam from the single fiber ferrule wherein the wedge prism system comprises two wedge prisms with a substantially 90 degree orientation to each other;
a wedge prism system for directing the beam from the single fiber ferrule;
a second lens for receiving the directed beam from the wedge prism system; and
a substantially square fiber ferrule, the substantially square fiber ferrule containing four fibers for receiving the beam from the second lens.

5. A 1x9 opto-mechanical switch comprising:
a single fiber ferrule;
a first lens for receiving a beam from the single fiber ferrule wherein the wedge prism system comprises two wedge prisms with a substantially 90 degree orientation to each other;
a wedge prism system for directing the beam from the single fiber ferrule;
a second lens for receiving the directed beam from the wedge prism system; and
a substantially square fiber ferrule, the substantially square fiber ferrule containing four fibers for receiving the beam from the second lens.

6. A 1x16 opto-mechanical switch comprising:
a single fiber ferrule;
a first lens for receiving a beam from the single fiber ferrule;
a wedge prism system for directing the beam from the single fiber ferrule wherein the wedge prism system comprises two wedge prisms with a substantially 90 degree orientation to each other;
a second lens for receiving the directed beam from the wedge prism system; and
a substantially square fiber ferrule, the substantially square fiber ferrule containing four fibers for receiving the beam from the second lens.
